(19) United States
(12) Patent Application Publication
(10) Pub. No.: US 2023/0368146 A1
(43) Pub. Date: Nov. 16, 2023

(54) METHODS AND SYSTEMS FOR PROVIDING ANALYSIS AND FEEDBACK FOR CANDIDATE MOCK INTERVIEWS

(71) Applicants: Salil Pande, Palo Alto, CA (US); Kiran Mishra Pande, Palo Alto, CA (US)

(72) Inventors: Salil Pande, Palo Alto, CA (US); Kiran Mishra Pande, Palo Alto, CA (US)

(21) Appl. No.: 16/675,222

(22) Filed: Nov. 6, 2019

Related U.S. Application Data
(60) Provisional application No. 62/755,559, filed on Nov. 5, 2018.

(51) Int. Cl. G06Q 10/1053

(52) U.S. Cl. CPC G06Q 10/1053

(57) ABSTRACT

In one aspect, A computerized method for tracking the improvement in the performance of a candidate over time comprising: determining a set of ways to measure an objective of the candidate; and obtaining mock input from the candidate.

### CROSS-REFERENCE TO RELATED APPLICATIONS

This application is a claims priority, to U.S. provisional patent application No. 62/755,559, titled METHODS AND SYSTEMS FOR PROVIDING ANALYSIS AND FEEDBACK FOR CANDIDATE MOCK INTERVIEWS and filed on 5 Nov. 2019. This provisional application is hereby incorporated by reference in its entirety.

### SUMMARY OF THE INVENTION

In one aspect, A computerized method for tracking the improvement in the performance of a candidate over time comprising: determining a set of ways to measure an objective of the candidate; and obtaining mock input from the candidate.

### BRIEF DESCRIPTION OF THE DRAWINGS

FIG. 1 illustrates an example process for tracking the improvement in the performance of a candidate over time, according to some embodiments.

FIG. 2 illustrates an example process for implementing candidate analysis from digital recordings of candidate mock input, according to some embodiments.

FIG. 3 illustrates an example table useful for implementing analysis of a candidate's mock input, according to some embodiments.

FIG. 4 illustrates an example process for measuring scored candidate performance parameters, according to some embodiments.

FIG. 5 illustrates an example technical process for implementing candidate analysis from digital recordings of candidate mock input, according to some embodiments.

FIG. 6 illustrate an image of example landmarks used by a face-detection algorithm, according to some embodiments.

FIG. 7 illustrates an example process for implementing detection algorithms and image processing, according to some embodiments.

FIG. 8 illustrates an example table including a summary of example algorithms utilized herein, according to some embodiments.

FIG. 9 illustrates an example process for additional methods provided herein, according to some embodiments.

FIG. 10 depicts an exemplary computing system that can be configured to perform any one of the processes provided herein.

FIG. 11 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for providing analysis and feedback for candidate mock interviews. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application can be a computer program designed to perform a group of coordinated functions, tasks and/or activities for the benefit of the user.

Application programming interface (API) can specify how software components of various systems interact with each other.

Biometrics is the technical term for body measurements and calculations.

Cloud computing can involve deploying groups of remote servers and/or software networks that allow centralized data storage and online access to computer services or resources. These groups of remote serves and/or software networks can be a collection of remote computing services.

Deep learning can use machine learning methods based on learning data representations (as opposed to task-specific algorithms). Deep learning can be supervised, semi-supervised or unsupervised. Deep learning architectures can include, inter alia: deep neural networks, deep belief networks, recurrent neural networks, etc.

Haar-like features are digital image features used in object recognition.

Machine learning is a type of artificial intelligence (AI) that provides computers with the ability to learn without being explicitly programmed. Machine learning focuses on the development of computer programs that can teach themselves to grow and change when exposed to new data.

Natural language processing (NLP) is a subfield of computer science, information engineering, and artificial intelligence concerned with the interactions between computers and human (natural) languages, in particular how to program computers to process and analyze large amounts of natural language data.

Recommendation system can be a subclass of information filtering system that seeks to predict the ‘rating’ or ‘preference’ that a user would give to an item.

Recurrent neural network (RNN) is a class of artificial neural network where connections between nodes form a directed graph along a sequence. This allows it to exhibit temporal dynamic behavior for a time sequence. Unlike feedforward neural networks, RNNs can use their internal state (memory) to process sequences of inputs.

Speech recognition is the inter-disciplinary sub-field of computational linguistics that develops methodologies and technologies that enables the recognition and translation of spoken language into text by computers. Speech recognition can include automatic speech recognition (ASR), computer speech recognition and speech to text (SIT).

### Example Methods

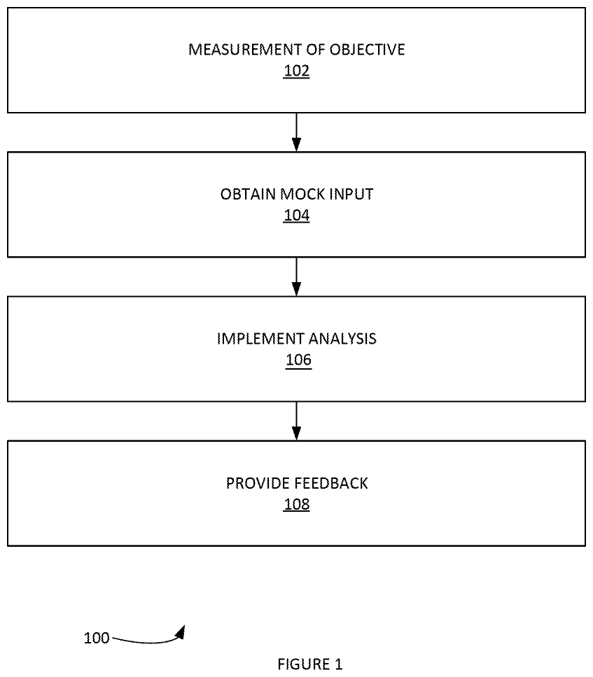

FIG. 1 illustrates an example process 100 for tracking the improvement in the performance of a candidate over time, according to some embodiments. In step 102, process 100 can determine ways to measure an objective of the candidate. This can be done based on a set of parameters (see example parameters infra). In step 104, process 100 can obtain mock input from the candidate. For example, videos of the candidate providing mock interview input and/or other pitches can be obtained and analyzed. The candidate can provide a series of such inputs. Process 100 can measure parameters of the candidate's performance over time. In this way, process 100 can be used to improve the chances of candidate's conversion.

In one example, process 100 can utilize the following parameters. Interview phobia can be a measure of the candidate's fear of opening in front of others. Camera consciousness can be a measure of the candidates practice speaking in front of camera. Content as a measure of the impact of specified content. Delivery style as a measure of different delivery type of the same content. Process 100 can also provide feedback with respect to improvement of specific aspects, such as, inter alia: speech rate, intensity, eye contact etc. Based on the measurement these parameters, process 100 can implement analysis of the candidate's speech/pitch. Process 100 can provide feedback accordingly.

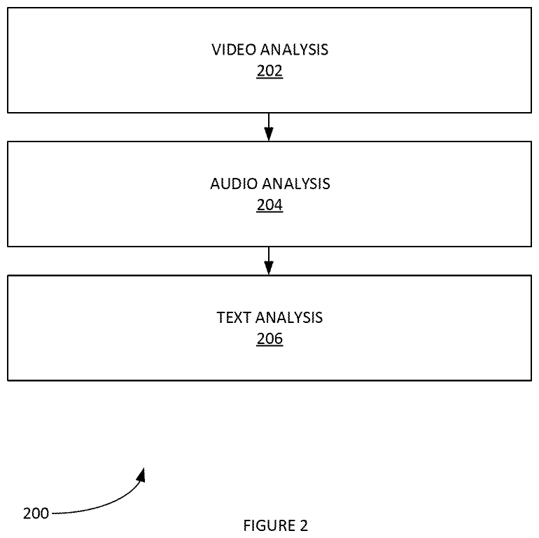

FIG. 2 illustrates an example process 200 for implementing candidate analysis from digital recordings of candidate mock input, according to some embodiments. As noted, process 100 can evaluate the students on a specified number of parameters/components. Process 200 can parse/analyze candidate mock input to obtain data used to score these parameters/components. It is noted that candidate mock input can be in the form of uploaded videos with the candidate speaking and text in the form candidate resumes, curriculum vitae, etc.

In step 202, process 200 can implement video analysis. Video analysis can include scoring the various aspects of an interviewee's body language, facial expressions, hand gestures, etc. Example parameters that can be measured, include, inter alia: gestures, eye contact, facial expression, body postures, appearance (e.g. grooming, sartorial, etc.), etc. In this way, process 200 can obtain information that can be used to score a candidate in terms of formality and presentably for a job interview, investor pitch, etc. Process 200 can score a user's body posture. For example, process 200 can score a candidate based on whether he/she sits toward the front of a chair, leans ahead slightly showing interest, etc. Process 200 can score a standing candidate based on the alignment of the candidate's neck, back, stomach and legs. Process 200 can score a candidate based on a smile frequency. These parameters are provided by way of example and not limitation. Additional parameters can be measured from the video as well.

In step 204, process 200 can implement audio analysis. Audio analysis can include scoring aspects of a candidate's speech (e.g. in terms of tone, inflection, clarity, volume, consistency, pronunciation, speed, content, etc.). Process 200 can measure the following parameters, inter alia: pitch and modulation, intensity and modulation, disfluencies, speech rate, average length of sentences, pauses, speech modulation, intensity, etc. It is noted that emitting proper sound is important for an interview. Intensity is the amount of sound reaching the eardrums. Frequency of the sound waves is known as pitch, and extremely high pitches are squeaking, etc. Process 200 can be used by a candidate to obtain the right sound to speech style. Speech rate can measure how quickly are a candidate speaking in an interview. Speech modulation is very important in an interview as you can use modulation in intensity, pitch, pause to highlight some points more than the rest. Accordingly, process 200 can help a candidate learn to modulate their speech while communicating achievements and other information.

In step 206, process 200 can implement text analysis—what an interviewee speaks. On the text side, process 200 can implement, inter alia: word-level analysis; sentence-level analysis; etc. Word-level analysis analyses for specific words that have been used in the speech. It includes, inter alia: negative words, action-oriented words, repetitive words, specifics, and discourse markers. Sentence-level analysis analyses the broad content the speech is about. It includes, inter alia: greetings, name, personal details, education, work-experience, achievements, interests, hobbies, gratitude. These can provide information about which components are being spoken about in an interview and which component students are missing out. Also, process 200 can be used to provide the candidates as to how to improve their speech and including what and avoiding what text context helps the interviewee in improving for interviews.

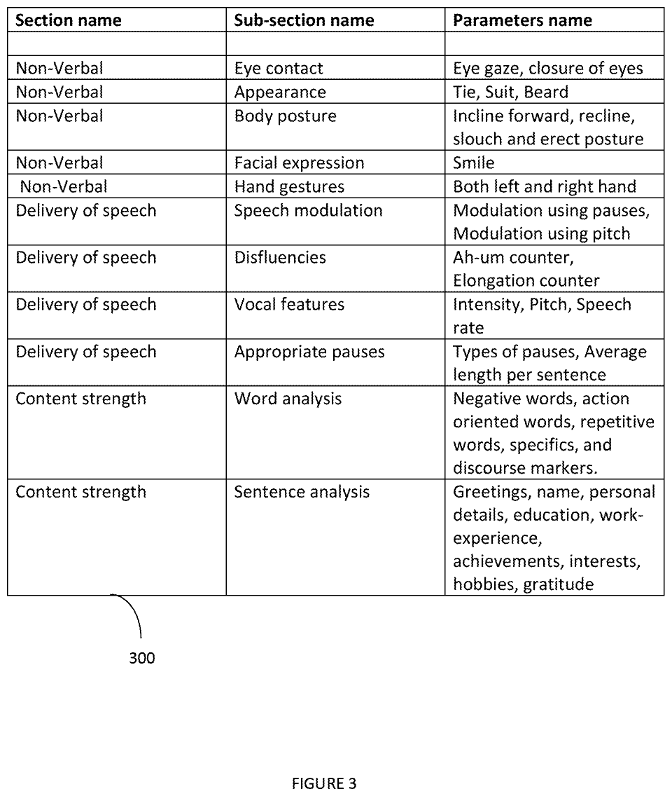

FIG. 3 illustrates an example table 300 useful for implementing analysis of a candidate's mock input, according to some embodiments. As shown in table 300, analysis can be implemented on various levels. For example, the feedback can be divided as: feedback levels. Feedback levels can be at the section level; sub-section level, parameter level. Section names can include, inter alia: non-verbal; delivery of speech; content strength; etc. Sub-section names can include, for example as well follows. The subsection for a non-verbal parameters include: eye contact; appearance; body posture; facial expression; hand gestures; etc. The sub-section in delivery of speech can include, inter alia: vocal features; appropriate pauses; disfluencies; speech modulation; etc. The sub-section in content strength can include, inter alia: word level analysis; sentence level analysis; etc.

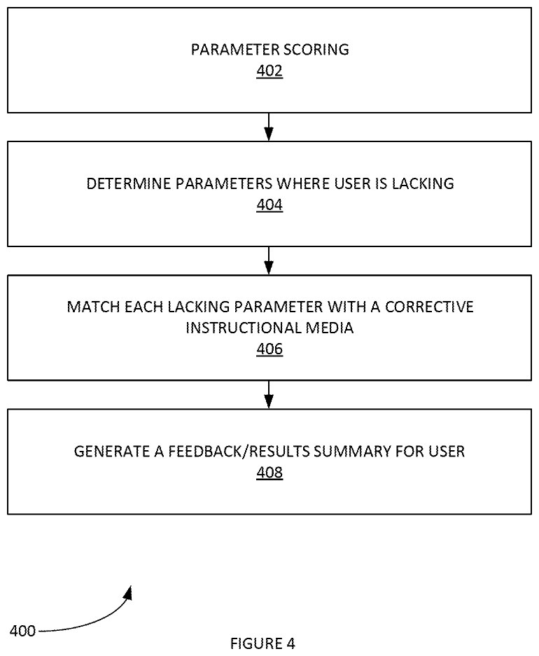

FIG. 4 illustrates an example process 400 for measuring scored candidate performance parameters, according to some embodiments. In step 402, process 400 can implement parameter scoring. Process 400 can score each parameter based on various best-industry practices. In one example, based on the parameter scores, process 400 can classify the performance of the interviewer in each section into three segments: ‘needs work’, ‘on track’, ‘good job’. Parameter scoring can also be implemented from machine learning models learned from a historical database of interviews.

In step 404, process 400 can determine parameters lacking in the candidate's presentation. Candidate performance can also be benchmarked with the competitors (e.g. both intra- and inter-colleges, among candidates for a particular job placement, etc.). The analytics can reveal problematic patterns and/or other issues. A combination of machine learning, deep neural networks, natural language processing can be utilized.

In step 406, process 400 can match each lacking parameter with a corrective instructional media. Based on the candidate's performance, wherever the candidate is lagging, a targeted sample video can be provided. The sample video can provide information as to how to improve the particular parameter. Additionally, relevant tips can be provided for improving each attribute. Candidates can follow the guidance and track improvement.

In step 408, process 400 can generate a feedback/results summary for user. In one example, a results page can be provided via a webpage, mobile-device application, etc. In one example, the results page can be divided in three segments: a summary page; a detailed feedback; and a video feedback. The summary page can show the overview of the candidates' performance for all the sections. The detailed feedback page can show performance of the candidates in each parameter, along with the recommended ranges.

This page can also display an improvement section, an illustration section, and an insights section. The improvement section can offer relevant short tips for improvement in any section. The illustration section can offer a broad guidelines on why the section is important in interviews and the general pitfalls students display and how to avoid them. The insights section offers detailed level historical performance of the candidate in that parameter. The video feedback page offers students a unique perspective where they can see their whole interview with marked intervals where they did good and bad in important parameters. This can offer a chance to the students not only to check the veracity of the evaluation framework but more importantly to connect with the evaluation and let the system show the mistakes. In this way, a candidate can gain a great understanding the problem(s) and assistance in rectifying said problems.

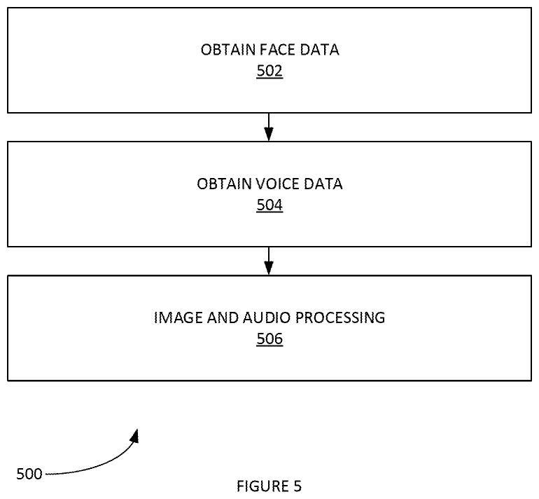

FIG. 5 illustrates an example technical process 500 for implementing candidate analysis from digital recordings of candidate mock input, according to some embodiments. In step 502, process 500 obtain candidate face data. In step 504, process 500 can obtain candidate voice data. The face and voice data can be obtained from digital recordings of a candidate's mock input (e.g. elevator pitch, employment interview practice session, educational institution interview, etc.). In step 506, process 500 can implement image and audio processing.

Process 500 can use deep and neural learning methods for image and speech processing tasks. Process 500 can utilize various face-detection algorithms, such as, for example, Haar Classifiers. Process 500 can leverage various open-source software packages such as, Opencv, that implements face-detection algorithms. For example, Opencv includes Haar classifiers with inbuilt face detection, eye detection and small objects detection. In some examples, A Haar-like feature considers adjacent rectangular regions at a specific location in a detection window, sums up the pixel intensities in each region and calculates the difference between these sums. This difference is then used to categorize subsections of an image. For example, let us say we have an image database with human faces. It is a common observation that among all faces the region of the eyes is darker than the region of the cheeks. Therefore, a common Haar feature for face detection is a set of two adjacent rectangles that lie above the eye and the cheek region. The position of these rectangles is defined relative to a detection window that acts like a bounding box to the target object (the face in this case). In the detection phase of the Viola-Jones object detection framework, a window of the target size is moved over the input image, and for each subsection of the image the Haar-like feature is calculated. This difference is then compared to a learned threshold that separates non-objects from objects, in a Viola-Jones object detection framework, the Haar-like features can be organized in a classifier cascade to form a strong learner or classifier.

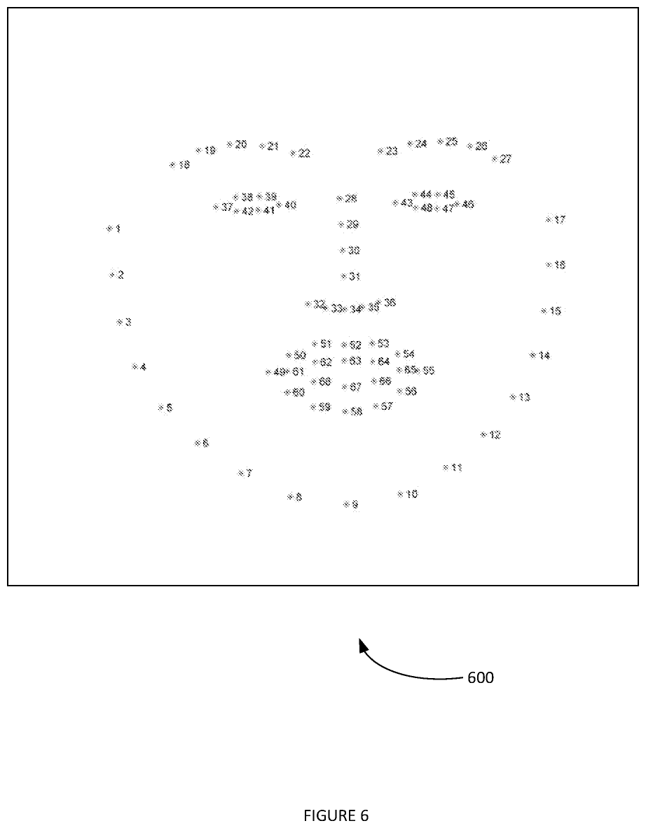

FIG. 6 illustrate an image of example landmarks used by a face-detection algorithm, according to some embodiments. The algorithm further detects a total of sixty-eight (68) landmark points on any face, an insight that can be used in indirect detection of other important features of human body.

Process 500 can use hand-detection to detect various gestures. Process 500 can use convolutional neural networks to capture important features of an image thereby making them quite robust enough to accurately identify a given object from an image (e.g. hand gesture, dress items, user grooming states, etc.)

Process 500 can use speech recognition is another area of research which has evolved widely from time to time. Process 500 can implement an advanced machine learning model for automatic speech recognition (ASR) leveraging using historical sets of speech data. Process 500 can apply natural language processing (NLP) upon the ASR results to obtain an overall set of metrics about the skillset of a candidate. Process 500 can also apply image and audio processing, in combination, to determine the metrics of candidate mock input for developing valuable feedback.

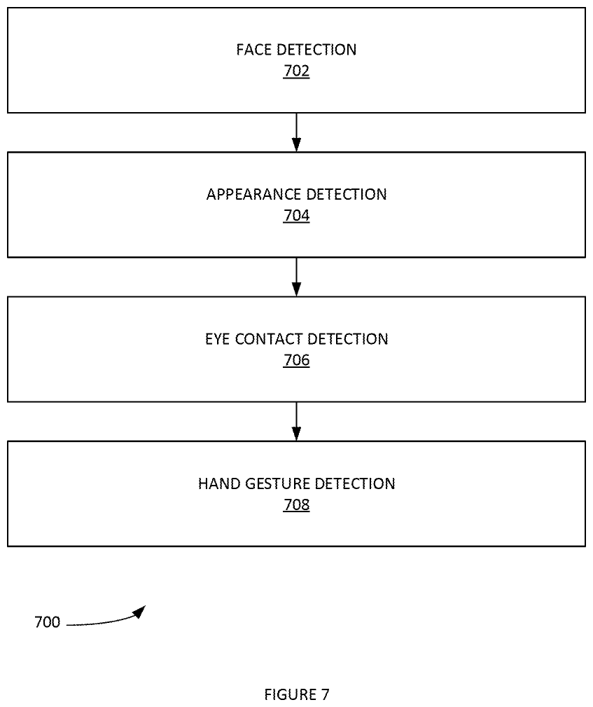

FIG. 7 illustrates an example process 700 for implementing detection algorithms and image processing, according to some embodiments. As noted in process discuss supra, video processing is an important step towards analyzing candidate mock input. A video is sequence of images with each image having its own characteristics. Accordingly, process 700 can implement detection algorithms that are implemented at the image level. The results thus obtained can be combined to obtain the overall performance of the candidate's mock input.

Process 700 image processing contains the following detection steps for the desired purpose. In step 702, process 700 can implement face detection. Process 700 can utilize the Dlib library to detect a face in an image. As noted, FIG. 6 illustrates the key elements detected in a face. In the model of FIG. 16, seventeen (17) points are detected representing the jaw boundary, ten (10) points representing the eyebrows, twelve (12) points depicting the eyes, nine (9) points characterizing the nose, ten (10) points rendering the upper lips, and the remaining ten (10) points representing the lower lips taking the tally to sixty-eight (68).

In step 704, process 700 can implement appearance detection. The points detected in the face can form the base for detecting indirect insights, such as, inter aka: presence of a smile, lean or straight posture, and other valuable insights required for an elevator pitch. Prior to detection, calibration operations can be implemented. In one calibration example, a small sequence of frames are used for getting raw inputs which set the benchmark for further analysis. These frames can provide the average face width, average face height, average mouth width, average nose angle and the average facial area (e.g. see Appendix A).

In post calibration operations, the images are analyzed as per the benchmarks set in the calibration phase leading to following detections. Posture can be analyzed using two ratios: a current face width to average face width and current face area to average face area. The threshold is used to determine whether the candidate is leaning forward or backward or is appropriately sitting in the right posture.

Smile detection and analysis can be implemented. A smile is detected if the ratio (e.g. a current mouth width to average mouth width, etc,) crosses a threshold. This threshold is dynamic and varies as the posture of the candidate varies. Facial tilts detection and analysis can be implemented. A facial tilt is considered if a person's face is not facing the screen within certain range. It can be lateral movement or side way movement. It can be detected by determining the ratio of current nose angle to average nose angle and ratio of current face width to average face width.

In step 706, process s700 can implement eye contact detection. Eye contact analysis can include detecting one or both pupils. Various pupil detection algorithms can be implemented. In one example, it can be assumed that pupil is black in color. The algorithm can search for a certain number of points in the black range in the eye region. This point(s) in the pupil can be used as a reference for eye contact detection. Calibration techniques can be employed here to obtain the center point of the eye. Using various thresholds, eye contact can be detected, and it can be determined whether the person is looking left, right, top or bottom.

In step 708, process 700 can implement hand gesture detection. Hand gestures can be used to provide an insight about how interactive the candidate is. This feature is detected using skin color prediction and an object tracking detection algorithm. The face can be separated from the image and the remaining image is fed into the detection algorithm. The detection algorithm can remove the pixels with colors other than skin color. The remaining image is then fed into the object tracking detection algorithm thereby keeping the hands which are moving, eliminating the static objects. The image used here can be converted to YCrCb scale from the standard RGB scale prior to feeding it into the above described algorithm. This is done to perform skin color detection in the converted scale. The image is then converted to black and white image (e.g. where white pixels denote presence of skin colored pixels). For detecting hands, white contours which satisfy certain logics (e.g. perimeter to area ratio, contour area ratio with respect to face area, displacement from previous frame) are considered.

More generally, process 700 can leverage computer vision, image processing, and machine vision to determine whether or not the image data contains some specific object, feature, or activity. Process 700 can use an object recognition (e.g. object classification) functionality for a set of pre-specified or learned objects or object classes to be recognized. These can include analysis of 2D positions in the image or 3D poses in a scene. Process 700 can leverage identification functionalities. Identification functionalities can recognize an individual instance of an object. Process 700 can leverage detection functionalities. Detection functionalities can scan digital image data for a specific condition.

In some embodiments, deep learning models can be used to detect advanced patterns which are difficult to predict using intuitive logics. Example detections that can made using machine learning models are, inter alia: suit detection, tie detection, beard detection, etc.

Process 700 can use deep learning models. Prior to proceeding to feature detection, an averaging algorithm can detect the illumination and the percentage of the candidate appearing in the image. Depending on the benchmarks, the image can run detection techniques upon them to prevent false detections. Data collection for deep learning methods can include pre-downloaded digital images that are refurbished to prepare for training using convolutional neural networks. Example images can be obtained by creating videos and extracting images from the same. An example outcome of the deep learning model can be a determination as to whether a specified image possessed a certain feature (or not).

Process 700 can use speech to text functionalities. The audio portion of a digital video can be converted from speech to text version. In one example, a neural network model can be modeled to perform speech-to-text conversion (e.g. using a CTC-LSTM architecture). In one example, a Web Speech API can be utilized.

Text analysis can then be implemented. The output that we receive form the Web Speech API is a raw text. Meaningful sentences can be obtained from the raw text. Process 700 can use a trained a bi-directional Recurrent Neural Network Model (RNN model). The Recurrent Neural Network Model can determine the punctuations in the raw text. The RNN model detects sentence boundaries and the corresponding boundary type (e.g. PERIOD, COMMA, QUESTION MARK, etc.).

Once a meaningful sentences is determined, process 700 can then locate categories into which these sentences fall into, which is the essence of the spoken sentences, These categories includes, inter alia: greetings, personal details, education, work-experience, achievements, hobbies, interest in the role being interviewed for, gratitude, etc. The sentence tree and POS tagging for each sentence is found using pre-trained machine learning models. Using the sentence tree and POS tagging, the subjects, objects and other information is found from the sentence. Sense2vec model (extension of word2vec model) is trained to find similarity between any two words. This information is used to extract entities and categorize sentences into the above written classes. Along with this, RNN models can be trained for sentence classification, which are used to improve prediction of classes. Gentle is a forced aligner tool for aligning transcript and audio. The RNN models can output a JSON file. The JSON file can include timestamps of aligned words (and/or also timestamps of phonemes present in the words) and detect all phoneme which are used to detect various disfluencies, any interruptions in the smooth flow of speech, and the like.

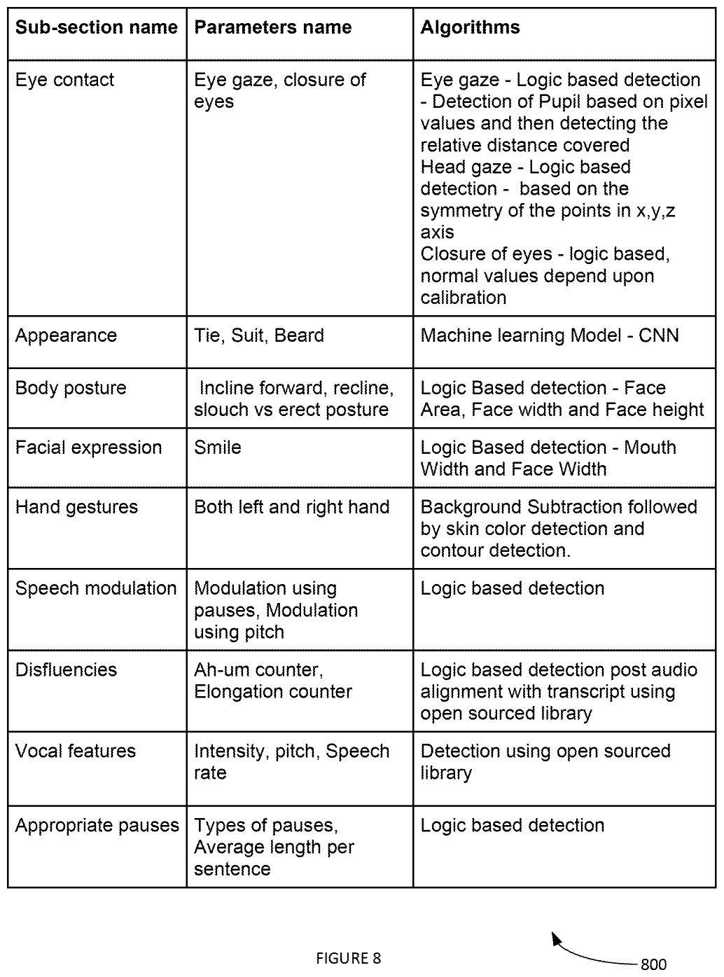

FIG. 8 illustrates an example table 800 including a summary of example algorithms utilized herein, according to some embodiments.

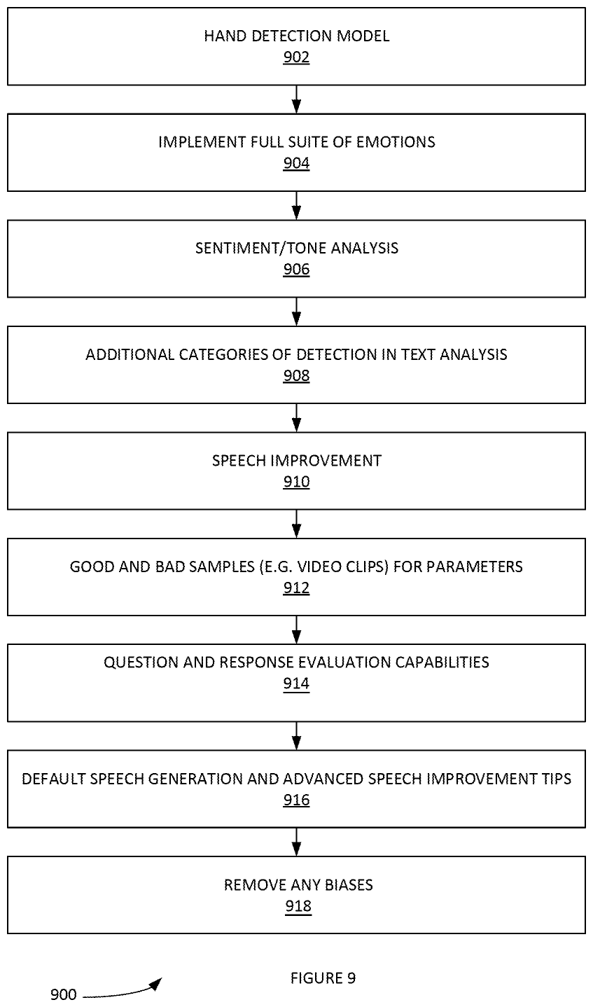

FIG. 9 illustrates an example process 900 for additional methods provided herein, according to some embodiments. In step 902, process 900 can implement a hand detection model. Process 900 can use a mix of background subtraction, skin color detection, and other logics to detect hands and/or hand gestures, Process 900 can train a machine-learning model to detect hands as well. For example, process 900 train You Only Look Once (YOLO) model(s) of various sizes that are optimized between the processing time and accuracy to determine an optimal size.

In step 904, process 900 can implement full suite of emotions. It is noted that process 900 can detect smiles in facial expression. Process 900 can also detect a full suite of emotions expressed by the candidate's facial expression during a mock input session. For example, six (6) basic emotions: happiness, surprise, sadness, anger, fear, disgust and a neutral emotion.

In step 906, process 900 can implement sentiment/tone analysis. Process 900 can analyze tone of speech. Example tones that can be detected, include, inter alia: factual, descriptive, analytical etc. Additionally, process 900 can detect positive and negative sentiments in speech (e.g. at the sentence and paragraph level). For example, process 900 can use a dataset of positive and negative words and a language model. The language model can learn the relations among words and how any positive or negative word impact the candidate. The language model can then be used to measure the confidence/sentiment of the candidate in sentences in which the candidate is discussing skills.

In step 908, process 900 can additional categories of detection in text analysis. Process 908 can detect various text-based entities, such as, inter alia: greeting, name, education, work-experience, achievements, interest in job/role, gratitude, etc. Process 900 can also be configured to detect other categories, such as: entrepreneurship, social work, positions of responsibility, awards, competitions, internships, sports etc.

In step 910, process 900 can provide speech improvement feedback. Process 900 can display the scores for speech modulation and disfluency. In one example, process 900 can prepare a practice module. The practice module can enable a candidate to practice and improve any specific parameter. The display can include feedback and improvement exercise.

In step 912, process 900 can provide good and bad samples (e.g. video clips) for parameters. It is noted that, along with the interview feedback, process 900 display video clips from the candidate's mock input in a detailed feedback page. For example, this can be a portion of the mock input where the candidate performed well or badly on a specified parameter. In this way, process 900 can enable the candidate to understand the areas requiring improvement and provide specific means for training said improvement.

In step 914, process 900 can implement question and response evaluations. In one example, process 900 can provide a question such as: “Tell me something about yourself”. The candidate's response can be evaluated, and feedback provided for improvement. Process 900 can include a set of questions that can be randomly asked to candidates to better prepare them for a complete interview.

In step 916, process 900 can provide speech generation and advanced speech improvement tips. Process 900 can include an interconnected platform where all the processes provided supra are integrated into a single insightful feedback system. In this way, candidates can prepare a base-level speech that relates to and is influenced by the best speeches that other high-performing candidates have prepared in the past. Additionally, process 900 can provide cues on the areas that have been avoided but should be included (e.g. from the candidate's resume, items the candidate's LinkedIn® profile, etc.).

In step 918 process 900 can remove any biases from candidate mock input evaluation and feedback system. Process 900 include functionalities for removing biases for or against any gender, race, color, minority or ethnicity and scoring algorithms are designed to avoid such biases. For example, process 900 can ensure that the facial detection algorithms are trained on people of all the races, castes, religions, ethnicities and/or genders to ensure it is not biased in any way. It is noted that in the evaluation of appearance section, process 900 can evaluate males for the presence of tie. In audio analysis, process 900 can be configured to specific languages, regional dialects and/or speech patterns that are appropriate for the interview the candidate is preparing for.

The processes provided herein and be used to derive a final score. The final score can be based the output of processes 100-900. Weightage of the outputs of these processes does not consider various irrelevant categories such as, inter alia: race, phenotype, caste, religion, gender, ethnicity, etc.

Additional examples are now discussed. It is noted that, in some embodiments, besides pointing the user towards various multi-media examples to bridge the gap, the systems herein can also implement auto-correcting operations to showcase what a revised version could appear as and then line up examples with small/incremental improvements (e.g. via multimedia means). The candidate can use this for improvement. Additionally, the feedback on a candidate's pitch can be compared with other relevant items (e.g. the candidate's resume and LinkedIn profile, etc.) to establish consistency and a consistency score can be generated. Similarly, a job description and previously successful and unsuccessful analysis can be used as a method to benchmark and filter candidates for employers. It is noted that similar deployment in other industries can manifest via multiple use cases. The systems provided can also index the candidate's video due to turning it into structured data that enable for searches by both a candidate and an employer or whatever the case might be. Furthermore, a real-time analysis and feedback about a live interviewee/interviewer interaction can be obtained and analyzed. This analysis can be communicated to both participants (e.g. a video or audio conference in real time, after the event, etc.). A functionality can also be provided for recruiters for compare candidates with an objective pitch analysis database.

### Example Computer Architecture and Systems

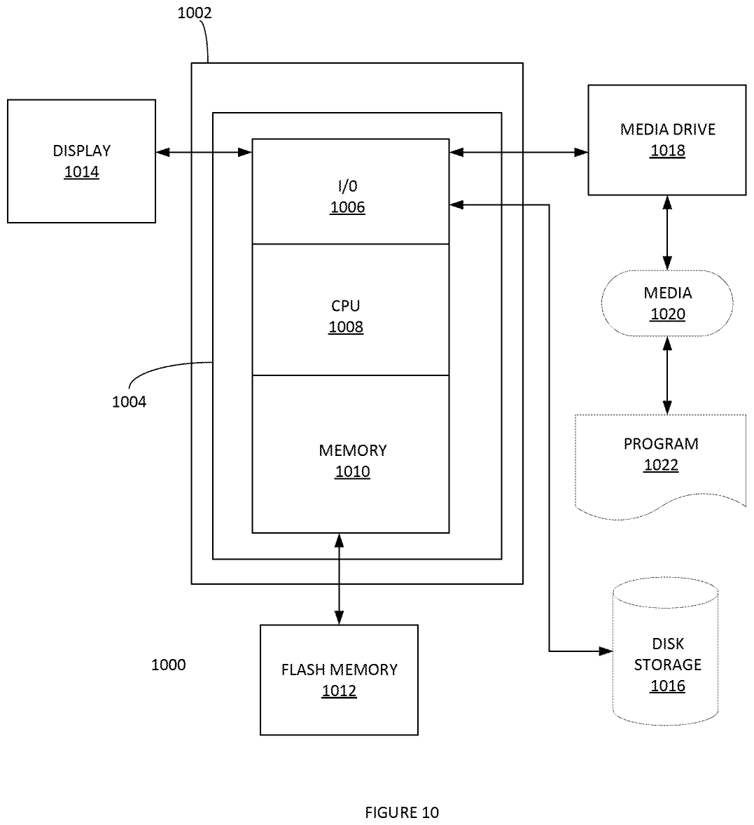

FIG. 10 depicts an exemplary computing system 1000 that can be configured to perform any one of the processes provided herein. In this context, computing system 1000 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

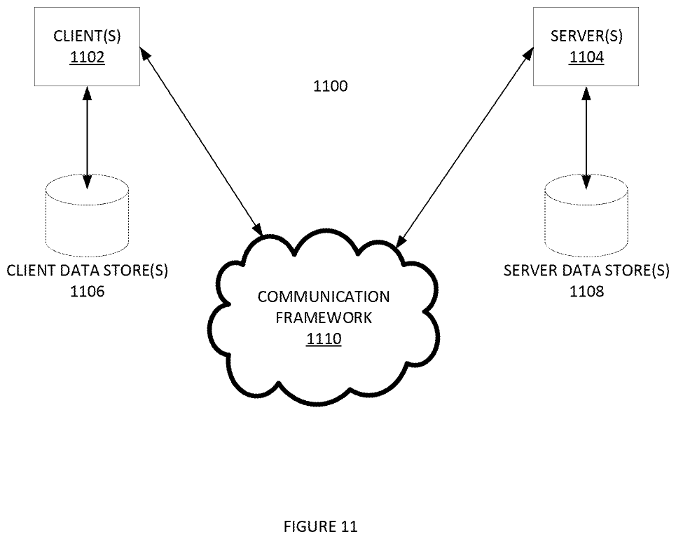

FIG. 11 is a block diagram of a sample computing environment 1100s that can be utilized to implement various embodiments. The system 1100 further illustrates a system that includes one or more client(s) 1102. The clients) 1102 can be hardware and/or software (e.g., threads, processes, computing devices). The system 1100 also includes one or more server(s) 1104. The servers) 1104 can also be hardware and/or software (e.g., threads, processes, computing devices). One possible communication between a client 1102 and a server 1104 may be in the form of a data packet adapted to be transmitted between two or more computer processes. The system 1100 includes a communication framework 1110 that can be employed to facilitate communications between the client(s) 1102 and the server(s) 1104. The client(s) 1102 are connected to one or more client data store(s) 1106 that can be employed to store information local to the client(s) 1102. Similarly, the server(s) 1104 are connected to one or more server data store(s) 1108 that can be employed to store information local to the server(s) 1104. In some embodiments, system 1100 can instead be a collection of remote computing services constituting a cloud-computing platform.

Appendix A includes additional information for implementing some example embodiments.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for tracking the improvement in the performance of a candidate over time comprising:
determining a set of ways to measure an objective of the candidate; and
obtaining mock input from the candidate.
